(19) United States
(12) Patent Application Publication
(10) Pub. No.: US 2008/0198346 A1
(43) Pub. Date: Aug. 21, 2008

(54) EXPOSURE APPARATUS AND METHOD FOR MANUFACTURING DEVICE

(75) Inventors: Akiko Iimura, Utsunomiya-shi (JP); Noriyasu Hasegawa, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/026,628

(22) Filed: Feb. 6, 2008

(30) Foreign Application Priority Data
Feb. 16, 2007 (JP) 2007-036600
Nov. 14, 2007 (JP) 2007-295594

(51) Int. Cl. G03B 27/52

(52) U.S. Cl. 355/30

(57) ABSTRACT

An exposure apparatus, exposing a substrate via liquid, includes a projection optical system that projects a pattern of an original onto the substrate and a substrate stage that holds and moves the substrate. The substrate stage includes a chuck that holds the substrate, a top plate that surrounds the substrate held by the chuck, and a draining mechanism that drains liquid on the top plate. The top plate has a first area and a second area on the surface of the top plate. At least part of the first area is formed between the substrate held by the chuck and the second area. The contact angle of the first area with the liquid is smaller than the contact angle of the second area with the liquid. The draining mechanism drains liquid on the first area.

### BACKGROUND OF THE INVENTION

1. Field of the Invention

The present invention relates to exposure apparatuses that expose substrates to light via liquid.

2. Description of the Related Art

Projection exposure apparatuses have been used to expose substrates held by chucks to light via circuit patterns formed on reticles and projection optical systems. Recently, high-resolution exposure apparatuses with excellent transfer accuracy and excellent throughput have been increasingly required. As a way to meet the demand for high resolution, immersion exposure has been attracting considerable attention. Immersion exposure is a technique for increasing the numerical aperture (NA) of the projection optical systems by using liquid as a medium disposed between the projection optical systems and the substrates held by the chucks. When n is the refractive index of the medium, NA of the projection optical systems can be expressed as NA=n×sin θ. Therefore, NA can be increased by up to n times that when the medium is air by using a medium having a refractive index higher than that of air, i.e., n>1. As a result, the resolution R of the exposure apparatuses, given by R=k1×(λ/NA), wherein k1 is a process factor and λ is the wavelength of light sources, can be improved.

In immersion exposure, a local-fill technology in which a gap between the last surface of a projection optical system and a substrate is locally filled with liquid has been discussed in International Publication No. WO 99/49504, Japanese Patent Laid-Open No. 2005-150734, and Japanese Patent Laid-Open No. 2006-186112.

In the local-fill technology, it is required that an amount of liquid in the narrow gap between the last surface of the projection optical system and the substrate is maintained by uniformly supplying liquid to the gap and recovering the liquid. When the liquid partially remains on a top plate that surrounds a chuck of a substrate stage and the substrate held by the chuck, for example, the top plate can be deformed by heat of vaporization, and accuracy in transferring patterns formed on reticles can be degraded. Moreover, an amount of liquid splattered in the vicinity of a liquid film or an amount of liquid partially remaining in the vicinity of the liquid film can be increased when the substrate stage is moved at high speed.

Furthermore, for example, the liquid partially remaining on the top plate or the substrate can be mixed with the liquid disposed in the gap between the last surface of the projection optical system and the substrate. In this case, bubbles can enter the liquid disposed in the gap. Since the bubbles included in the liquid diffusely reflect exposure light, the throughput can be reduced due to a reduction in the amount of exposure light, and transfer accuracy can be degraded due to less exposure light reaching the substrate.

To solve the above problems, a method for dealing with the bubble formation and the liquid leakage by setting the contact angle of the substrate or a substrate table for holding the substrate with the liquid (immersion liquid) to more than 90° is discussed in Japanese Patent Laid-Open No. 2005-150734.

In addition, the transfer accuracy can be degraded when the liquid partially remaining on the top plate is moved onto the substrate together with impurities on the top plate.

To solve this problem, a method for preventing the liquid from moving onto the substrate is discussed in Japanese Patent Laid-Open No. 2006-186112. In this method, a surface of a substrate supporter is set such that the contact angle of the surface of the substrate supporter with liquid is continuously or intermittently reduced from portions adjacent to the outer periphery of the substrate to the outside. Moreover, in this method, a liquid collecting mechanism is disposed outside the area of the surface set as described above.

In an exposure apparatus described in Japanese Patent Laid-Open No. 2005-150734, the liquid is prevented from remaining by setting the contact angles of the substrate and the substrate table for holding the substrate with the immersion liquid to more than 90°. However, the liquid film is split and remaining of the liquid occurs as shown in FIG. 8B when the substrate table is moved at high speed over a long distance. The liquid remaining on the surface with high liquid repellency can be easily moved, and splatters while the substrate table is moved at high speed.

FIG. 8A is a schematic view of a lens barrel of a projection optical system viewed from a −Z direction, and FIG. 8B is a cross-sectional view of the lens barrel. During exposure, liquid (immersion liquid) is disposed under a lens barrel 32′ while the liquid is supplied via liquid supply ports 101′ and recovered via liquid recovery ports 103′. However, the liquid is split while the substrate stage is moved at high speed and remains on a top plate 44′ as shown in FIG. 8B. When the liquid remaining on the top plate is mixed with the liquid disposed under the lens barrel again in accordance with the high-speed movement of the substrate stage, bubbles can be generated in the mixture, and can enter under the lens barrel.

Moreover, in an exposure apparatus described in Japanese Patent Laid-Open No. 2006-186112, the liquid is prevented from moving onto the substrate by setting the surface of the substrate supporter such that the contact angle of the substrate supporter with the liquid is continuously or intermittently reduced from the portions adjacent to the outer periphery of the substrate to the outside. However, the liquid collecting mechanism is disposed outside the area of the surface set as described above, thereby the liquid partially remaining on the area cannot be discharged easily. In particular, it is difficult to efficiently discharge the liquid partially remaining in an area close to the exposure region, which exerts a large influence on the degradation of the transfer accuracy.

### SUMMARY OF THE INVENTION

An aspect of present invention is directed to an exposure apparatus having excellent transfer accuracy and excellent throughput.

According to an aspect of the present invention, an exposure apparatus, exposing a substrate via liquid, includes a projection optical system that projects a pattern of an original onto the substrate and a substrate stage that holds and moves the substrate. The substrate stage includes a chuck that holds the substrate, a top plate that surrounds the substrate held by the chuck, and a draining mechanism that drains liquid on the top plate. The top plate has a first area and a second area on the surface of the top plate. At least part of the first area is formed between the substrate held by the chuck and the second area. The contact angle of the first area with the liquid is smaller than the contact angle of the second area with the liquid. The draining mechanism drains liquid disposed on the first area.

Further features and aspects of the present invention will become apparent from the following description of exemplary embodiments with reference to the attached drawings.

### BRIEF DESCRIPTION OF THE DRAWINGS

FIG. 1 is a cross-sectional view of an example exposure apparatus according to a first exemplary embodiment of the present invention.

FIGS. 2A and 2B are cross-sectional views illustrating a part of the exposure apparatus.

FIGS. 3A to 3D are cross-sectional views illustrating the effect of the exemplary embodiment.

FIG. 4A is a cross-sectional view illustrating a part of the exposure apparatus, and FIG. 4B is a cross-sectional view of a top plate.

FIGS. 5A to 5D are top views illustrating example layouts of first and second areas on the top plate.

FIG. 6A is a cross-sectional view of the top plate including openings, and FIGS. 6B to 6D are top views illustrating examples of shapes of the openings formed in the top plate.

FIG. 7A is a cross-sectional view of the top plate including a supporting member of the first area, and FIG. 7B is a top view of the top plate including the supporting member of the first area.

FIGS. 8A and 8B illustrate problems associated with an exposure apparatus.

FIG. 9 is a cross-sectional view illustrating a part of an exposure apparatus according to a second exemplary embodiment.

FIG. 10 is a cross-sectional view illustrating a part of an exposure apparatus according to a third exemplary embodiment.

FIG. 11 is a cross-sectional view illustrating a part of an exposure apparatus according to a fourth exemplary embodiment.

FIG. 12 is a flow chart of manufacturing devices.

FIG. 13 is a flow chart illustrating wafer processing in detail.

FIG. 14 is a cross-sectional view illustrating a part of an exposure apparatus according to a fifth exemplary embodiment.

FIG. 15 is a cross-sectional view illustrating the part of the exposure apparatus according to the fifth exemplary embodiment.

FIG. 16 is a cross-sectional view illustrating a part of an exposure apparatus according to a sixth exemplary embodiment.

FIG. 17 is a cross-sectional view illustrating the part of the exposure apparatus according to the sixth exemplary embodiment.

### DESCRIPTION OF THE EMBODIMENTS

Various exposure apparatuses, features and aspects thereof, according to exemplary embodiments of the present invention will now be described with reference to the drawings. The same reference numbers and symbols are used for the same or similar components in the drawings, and the descriptions thereof will be omitted.

### First Exemplary Embodiment

### [Exposure Apparatus]

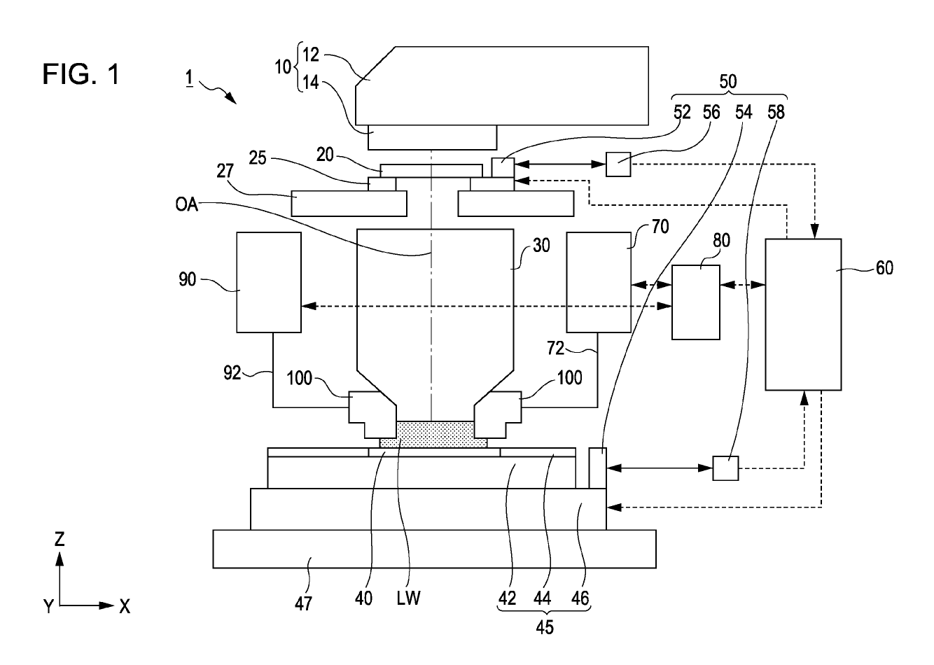

FIG. 1 is a cross-sectional view of an example exposure apparatus 1 according to a first exemplary embodiment. The exposure apparatus 1 is an immersion projection exposure apparatus that exposes a substrate 40 held by a chuck 42 to light via a circuit pattern formed on a reticle 20, a projection optical system 30, and liquid LW supplied to a space between the projection optical system 30 and the substrate 40 using a step-and-scan technique. The exposure apparatus 1 can employ a step-and-repeat technique.

As shown in FIG. 1, the exposure apparatus 1 includes an illumination device 10, a reticle stage 25 that holds and moves the reticle 20, the projection optical system 30, and a substrate (wafer) stage 45 that holds and moves the substrate 40. The exposure apparatus 1 further includes a base 47 that supports the substrate stage 45, ranging devices 50, a stage controller 60, and other components. The other components include, for example, a liquid supply unit 70, an immersion controller 80, a liquid recovery unit 90, and a nozzle member 100.

The illumination device 10 illuminates the reticle 20 having a circuit pattern formed thereon, the pattern being transferred to the substrate. The illumination device 10 includes a light source unit 12 and an illumination optical system 14.

The light source unit 12 in this exemplary embodiment includes an ArF excimer laser having a wavelength of approximately 193 nm as a light source. However, the light source is not limited to the ArF excimer laser, and can be, for example, a KrF excimer laser having a wavelength of approximately 248 nm, an F₂ laser having a wavelength of approximately 157 nm, and a lamp such as a mercury lamp and a xenon lamp.

The illumination optical system 14 illuminates the reticle 20 using light emitted from the light source unit 12.

The reticle 20 is carried from outside the exposure apparatus 1 by a reticle conveying system (not shown), and held and moved by the reticle stage 25. The reticle 20 is composed of, for example, quartz, and has a pattern formed thereon. The image of the pattern is projected onto the substrate 40 held by the chuck 42 using the projection optical system 30. The reticle 20 and the substrate 40 are disposed so as to be optically conjugate to each other. Since the exposure apparatus 1 is of the step-and-scan type, the reticle 20 and the substrate 40 are scanned at a speed ratio equal to the demagnification ratio of the projection optical system 30 so that the pattern of the reticle 20 is transferred onto the substrate 40. When the exposure apparatus is of the step-and-repeat type, the reticle 20 and the substrate 40 stand still during exposure.

The reticle stage 25 is supported by a base 27. The reticle stage 25 holds the reticle 20 via a reticle chuck (not shown), and the position of the reticle stage 25 is controlled by a moving mechanism (not shown) and the stage controller 60. The moving mechanism includes a linear motor, and is capable of moving the reticle stage 25 in a scanning direction (X-axis direction in this exemplary embodiment).

The projection optical system 30 forms the image of the pattern of the reticle 20 onto the substrate 40. The projection optical system 30 can be a dioptric system or a catadioptric system. The projection optical system 30 includes a lens (final lens) that is brought into contact with the liquid LW. The final lens can be a plano-convex lens having a flat surface to be brought into contact with the liquid LW. The projection optical system 30 is a coaxial optical system and has an optical axis OA.

The substrate 40 is carried from outside the exposure apparatus 1 by a substrate conveying system (not shown), and is held and moved by the substrate stage 45. The substrate 40 is an object to be exposed to light, and can be a semiconductor substrate, a glass substrate, or the like. The substrate 40 is coated with a photoresist.

A top plate (liquid support plate) 44 surrounds the substrate 40 held by the chuck 42, and the surface thereof is substantially flush with the surface of the substrate 40. The top plate 44 is used to support the liquid LW. Since the surface of the top plate 44 has substantially the same height as that of the substrate 40, the liquid LW can also be formed at areas outside the substrate 40. Thus, a stable liquid film can be retained under the projection optical system 30 during exposure of a shot area in the vicinity of the outer periphery of the substrate 40.

The substrate stage 45 includes the chuck 42, the top plate 44, and a movable table 46. The substrate stage 45 is supported by the base 47, and holds the substrate 40 via the chuck 42. The substrate stage 45 is controlled by the stage controller 60, and can translate the substrate 40 in the X-axis, Y-axis, and Z-axis directions and rotate the substrate 40 about these axes. During exposure, the substrate stage 45 is controlled by the stage controller 60 such that the surface of the substrate 40 consistently coincides with a focal plane (image plane) of the projection optical system 30 with high accuracy.

The ranging devices 50 measure the position of the reticle stage 25 and the two-dimensional position of the substrate stage 45 in real time via reference mirrors 52 and 54 and laser interferometers 56 and 58. The measurement results obtained by using the ranging devices 50 are transmitted to the stage controller 60. The stage controller 60 controls the movement of the reticle stage 25 and the substrate stage 45 on the basis of the measurement results so as to position and synchronously control the reticle stage 25 and the substrate stage 45.

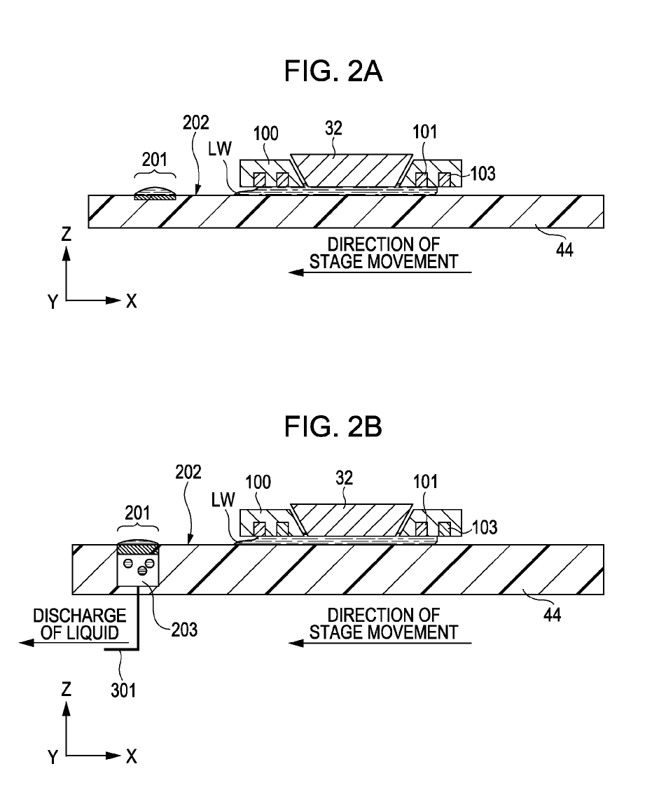

Supply and recovery of liquid will now be described with reference to FIGS. 1 and 2A. The liquid supply unit 70 shown in FIG. 1 supplies the liquid LW to the space or the gap formed between a final optical member 32 of the projection optical system 30 shown in FIG. 2A and the top plate 44 or the substrate 40. In this exemplary embodiment, the liquid supply unit 70 shown in FIG. 1 includes a liquid purifier, a deaerator, a temperature controller (all of which are not shown), and a liquid supply line 72. The liquid supply unit 70 supplies the liquid LW via liquid supply ports 101 shown in FIG. 2A formed around the final face of the projection optical system 30, thereby forming a liquid film of the liquid LW in the space between the projection optical system 30 and the substrate 40. The distance between the projection optical system 30 and the substrate 40 is preferably large enough to allow the liquid film of the liquid LW to be formed and to be removed stably, and can be, for example, 1.0 mm.

The liquid supply unit 70 includes, for example, a tank for storing the liquid LW, a pumping unit for sending out the liquid LW, and a flow control unit for adjusting the flow rate of the liquid LW.

The liquid LW can be selected from those that absorb a small amount of exposure light. Furthermore, the liquid LW can have a refractive index that is substantially the same as that of a refractive optical element, composed of quartz, fluorite, or the like constituting the projection optical system 30. The liquid purifier reduces impurities such as metallic ions, fine particles, and organic substances contained in raw liquid supplied from a liquid supply source (not shown) so as to refine the liquid LW. The liquid LW refined by the liquid purifier is supplied to the deaerator.

The deaerator deaerates the liquid LW, thereby reducing oxygen and nitrogen dissolved in the liquid LW. The deaerator includes, for example, a film module and a vacuum pump. The deaerator can be a unit having a first area to which the liquid LW is supplied, a second area in which a vacuum is produced, and a gas permeable film interposed therebetween such that gases dissolved in the liquid LW are expelled to the vacuum via the film.

The temperature controller controls the temperature of the liquid LW such that the liquid LW is maintained at a target temperature.

The liquid supply line 72 supplies the deaerated and temperature-controlled liquid LW to the space between the projection optical system 30 and the substrate 40 held by the chuck 42 via the liquid supply ports 101 formed in the nozzle member 100. That is, the liquid supply line 72 is connected to the liquid supply ports 101. The nozzle member 100 is supported so as not to be brought into direct contact with the final optical member 32 of the projection optical system 30.

The immersion controller 80 retrieves information on, for example, the current position, speed, acceleration, target position, and the direction of movement of the substrate stage 45 from the stage controller 60, and controls the immersion exposure process (supply and recovery of liquid) on the basis of the information. The immersion controller 80 provides the liquid supply unit 70 and the liquid recovery unit 90 with control instructions on, for example, starting and stopping the supply of the liquid LW, starting and stopping the recovery of the liquid LW, and adjusting the amount of the liquid LW to be supplied or recovered.

The liquid recovery unit 90 recovers the liquid LW supplied by the liquid supply unit 70. In this exemplary embodiment, the liquid recovery unit 90 includes a liquid recovery line 92. The liquid recovery unit 90 further includes, for example, a tank for temporarily storing the recovered liquid LW, a suction unit for drawing up the liquid LW, and a flow control unit for controlling the flow rate of the liquid LW being recovered. The liquid recovery line 92 is connected to liquid recovery ports 103 formed in the nozzle member 100.

The liquid LW can be, for example, pure water, functional water, and fluorinated liquid (e.g., fluorocarbon). The liquid LW can be a liquid whose dissolved gases have been sufficiently removed in advance by using the deaerator (not shown). With this, the generation of bubbles in the liquid LW can be suppressed, and, even if bubbles are generated in the liquid LW, the bubbles can be immediately absorbed in the liquid LW. For example, when nitrogen and oxygen, which are contained in large proportions in air, are removed by 80% of gas volume dissolvable in the liquid LW, the generation of bubbles can be sufficiently suppressed. The deaerator (not shown) can be provided for the exposure apparatus such that the liquid LW is supplied to the liquid supply unit 70 while gases dissolved in the liquid are continuously removed by the deaerator.

The liquid supply line 72 and the liquid recovery line 92 can be composed of resin that has a small amount of substance elution, such as polytetrafluoroethylene resin, polyethylene resin, and polypropylene resin, so as not to contaminate the liquid LW. In the case where the liquid LW is other than pure water, the liquid supply line 72 and the liquid recovery line 92 can be composed of materials that are resistant to the liquid LW and that have a small amount of substance elution.

Porous members can be fitted into the liquid supply ports 101. The porous members can be porous sinters made from, in particular, fibrous or granular (pulverized) metallic materials or inorganic materials. The porous sinters (at least the surfaces thereof) can be composed of, for example, stainless steel, nickel, alumina, silicon dioxide (SiO₂), silicon carbide (SiC), and SiC having SiO₂ formed on only the surface thereof by heat treatment.

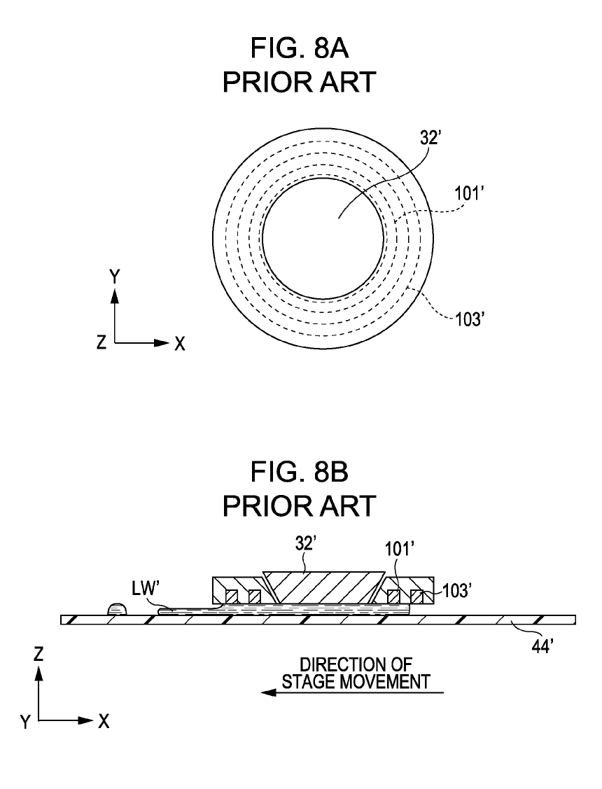

As shown in FIG. 8B, liquid LW′ extends on the top plate 44′ while a substrate stage is moved at high speed over a long distance, and is split when the liquid LW′ extends to a certain degree even in the case where the top plate 44′ is composed of a material with high liquid repellency (water repellency). In the case shown in FIG. 8B, it is difficult to specify the position at which the liquid LW′ is split during exposure. Therefore, in this exemplary embodiment, the position at which the liquid LW′ is split is specified using the structure described below so that the split liquid is not splattered on other sites.

The features of the top plate 44 will now be described with reference to FIGS. 2A and 2B.

FIG. 2A illustrates a state of the liquid LW when the substrate stage 45 is moved in a −X direction at high speed over a long distance. As shown in FIG. 2A, the top plate 44 has a first area 201 and a second area 202 adjacent to each other on the surface thereof. The contact angle of the first area 201 with immersion liquid differs from that of the second area 202. Herein, the first area 201 is lyophilic (the contact angle of the first area 201 with the liquid LW is less than 90°), and the contact angle of the second area 202 with the liquid LW is larger than that of the first area 201.

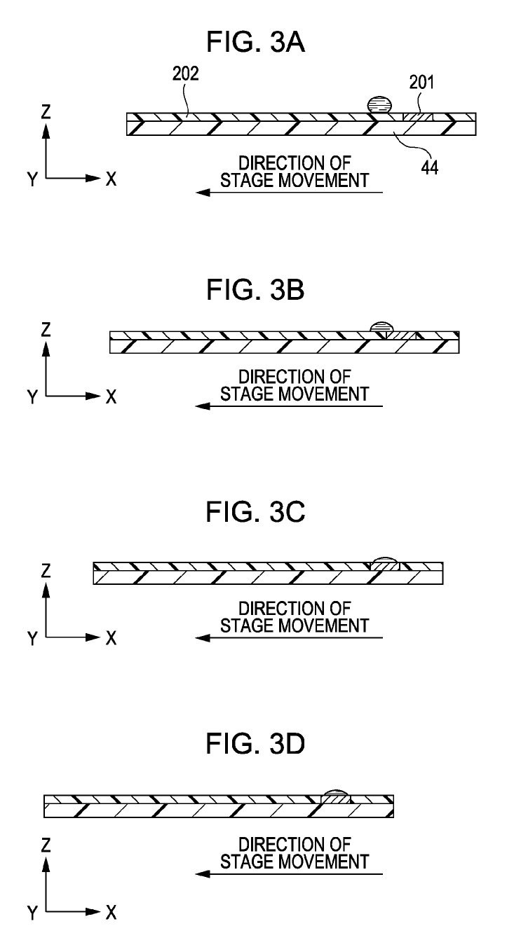

The effects of the first area 201 and the second area 202 adjacent to each other and having different contact angles will now described in detail with reference to FIGS. 3A to 3D. FIG. 3A is a cross-sectional view of the liquid split by, for example, high-speed movement of the substrate stage 45. The split liquid is moved on the second area 202 in accordance with the movement of the substrate stage 45, and reaches the first area 201 that is more lyophilic than the second area 202 as shown in FIG. 3B. Since the first area 201 has an affinity for the liquid as shown in FIG. 3C, the liquid moved on the second area 202 remains on the first area 201 as shown in FIG. 3D even when the substrate stage 45 is further moved. When the top plate 44 has such two areas adjacent to each other and having different contact angles, the droplet of liquid can be collected on the more lyophilic area.

In this exemplary embodiment, liquid on the top plate 44 is collected on the first area 201 using this effect, and is discharged via the first area 201.

When the two areas adjacent to each other and having different contact angles are compared, the liquid can be easily split and retained on the area having a smaller contact angle.

As shown in FIG. 2A, when the first area 201 having a contact angle smaller than that of the second area 202 passes under the liquid LW, the split liquid remains on the first area 201. With this, the amount of the liquid LW extending from under the final optical member 32 can be reduced, and the liquid is prevented from remaining on sites other than the first area 201. Moreover, even if the liquid is split and splattered at positions other than the first area 201, the splattered liquid can be collected on the first area 201 when the liquid is moved onto the first area 201 since the liquid gathers at the lyophilic area.

As shown in FIG. 2B, the first area 201 can be composed of a porous member or a porous material, and a first space 203 and drainage pipes 301 serving as a draining mechanism can be connected to the first area 201. The first space 203 is disposed inside the top plate 44 under the first area 201, and the drainage pipes 301 are connected to the first space 203. The liquid remaining on the first area 201 permeates into the lyophilic porous member, and falls into the first space 203. The liquid collected in the first space 203 is discharged via the drainage pipes 301. With this structure, the liquid remaining on the first area 201 does not remain for a long time, and the amount of splattered liquid can be further reduced.

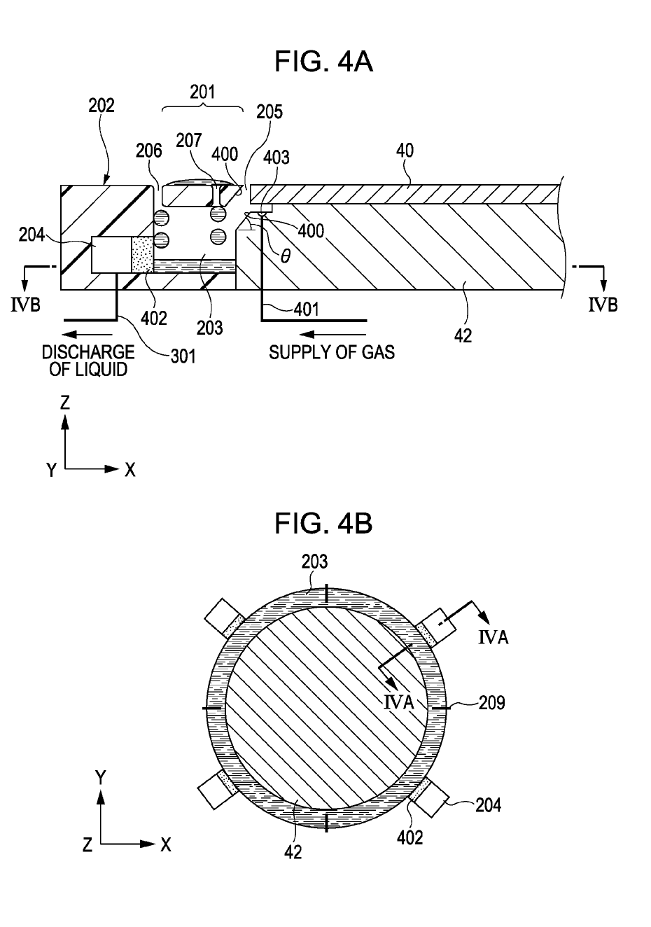

FIGS. 4A and 4B illustrate an example structure for retaining the liquid on the first area of the surface of the top plate 44 adjacent to the surface of the substrate 40. FIG. 4A is a cross-sectional view illustrating a part in the vicinity of the top plate 44 adjacent to the substrate 40, and FIG. 4B is a cross-sectional view of the top plate 44 taken along line IVB-IVB in FIG. 4A perpendicular to the direction of the cross-sectional view shown in FIG. 4A.

The liquid collected on the first area 201 is discharged by the draining mechanism via a second gap 206 and a third gap (also referred to as an opening) 207. The draining mechanism can include the first space 203, porous bodies 402, second spaces 204, and the drainage pipes 301. The draining mechanism moves the liquid collected in the first space 203 to the second spaces 204 via the porous bodies 402, and discharges the liquid via the drainage pipes 301.

Next, the structure shown in FIGS. 4A and 4B will be described in detail. The substrate 40, the first area 201, and the second area 202 are located on the surface with which the liquid LW comes into contact in this order from the center of the substrate 40 toward the outside. Herein, the contact angle of the first area 201 with the liquid LW is smaller than that of the surface of the substrate 40 with the liquid LW. Moreover, the contact angle of the second area 202 with the liquid LW is larger than that of the first area 201 with the liquid LW. With this structure, the amount of liquid remaining on areas close to the substrate (exposure region) on the top plate 44, which can cause detrimental effects on the accuracy in transferring the pattern to the substrate, can be reduced. Moreover, the amount of liquid remaining on the first area 201 of the top plate 44 can be reduced, thereby the liquid can be prevented from being splattered outside the top plate 44.

Next, the plurality of gaps formed between the substrate 40 and the top plate 44 and formed in the top plate 44 will be described in detail. A first gap 205 is formed between the substrate 40 and the top plate 44. The size of the first gap is changed in accordance with errors in the outer diameter of the substrate and errors in the substrate conveyance. When the size of the gap is increased, the amount of liquid falling from the gap is increased, and the amount of the liquid LW located under the final optical member becomes deficient. Moreover, air can easily enter the liquid LW while the liquid falls, and can cause exposure failure.

Accordingly, the inclined surfaces (repellent portions 400 in FIG. 4A) of the top plate 44 and the chuck 42 that form the first gap 205 are processed so as to be liquid-repellent. With this, the amount of liquid entering the first gap 205 can be reduced, and the amount of liquid falling into the first space 203 can be reduced. Herein, an angle θ shown in FIG. 4A can be set to less than 60° in order to reduce the amount of liquid falling into the first space 203. When the angle θ is less than 60°, i.e., when the inclination is gentle, the size of the gap formed between the inclined surfaces of the top plate 44 and the chuck 42 can be reduced. Thus, the amount of liquid falling into the first space 203 can be further reduced. Moreover, the liquid collected in the first space 203 can be prevented from being splattered from the gap formed between the inclined surfaces of the top plate 44 and the chuck 42 onto the surface of the substrate 40 and the like even when the liquid is agitated in accordance with the movement of the substrate stage 45.

When the liquid remains on the first area 201, the liquid can be moved from the first area 201, and can remains on sites other than the first area 201. To avoid this, the second gap 206 and the third gap 207 are formed in the top plate 44 such that the liquid is efficiently moved into the first space 203. The second gap 206 is formed at the boundary between the first area 201 and the second area 202. The third gap 207 is formed in the first area 201 adjacent to the first gap 205. The numbers and/or the shapes of the gaps are not limited to these, and can be changed as appropriate so that the liquid is discharged via the first area 201.

Moreover, gas supply pipes 401 and gas supply ports 403 for supplying gas to the first space 203 can be provided for the chuck 42 so as to assist the liquid to move into the second spaces 204 by supplying gas from the gas supply ports 403. This structure can cause secondary effects of preventing the liquid from entering the back surface of the substrate 40.

The second spaces 204 are not necessarily formed along the entire circumference of the substrate 40 as shown in FIG. 4B as long as the liquid collected in the first space 203 can be moved into the second spaces 204 and discharged therefrom. When the second spaces 204 are formed only adjacent to the drainage pipes 301 instead of the entire circumference of the substrate 40, deformation of the top plate 44 caused by heat of vaporization can be reduced as compared with the case where the second spaces 204 are formed along the entire circumference of the substrate 40. Furthermore, the performance of controlling the substrate stage 45 having the top plate 44 placed thereon can be prevented from being degraded. Moreover, when the second spaces 204 are formed only adjacent to the drainage pipes 301 instead of the entire circumference of the substrate 40, the temperature of the top plate 44 can be easily adjusted by a temperature-adjusting mechanism (not shown) since the positions to be cooled by heat of vaporization are limited in the vicinity of the porous bodies 402.

When the liquid collected in the first space 203 is discharged via openings such as pinholes and slits instead of the porous bodies 402, reductions in temperature caused by heat of vaporization can be further regulated.

Moreover, the lower surface (bottom surface) of the first space 203 perpendicular to the Z-axis direction can be composed of a lyophilic material, or can be processed so as to be lyophilic. With this, the liquid falling into the first space 203 can be spread on the lower surface, and can easily reach the porous bodies 402, resulting in an improvement in the draining efficiency.

Furthermore, as shown in FIG. 4B, the first space 203 can be sectioned by partitions 209 at a plurality of positions (four in FIG. 4B). With this, the liquid collected in the first space 203 cannot be easily agitated in accordance with the movement of the substrate stage 45, and the liquid can be smoothly discharged. Moreover, the vibration of the substrate stage 45 caused by the agitation of the liquid can be reduced by inserting the partitions into the first space 203.

The top plate 44 can have other structures at the portion adjacent to the substrate 40 as long as the variations in the first gap can be reduced.

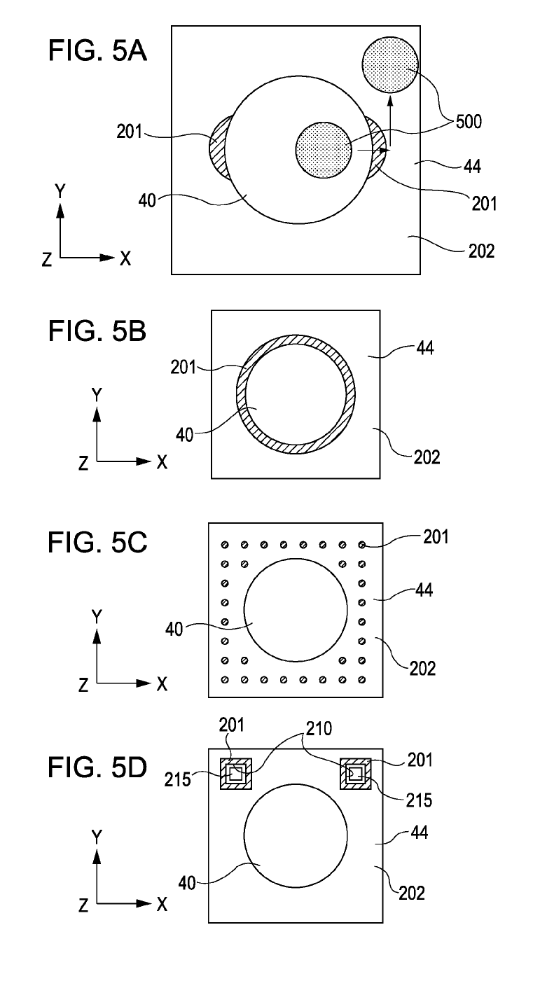

Another example of the layout of the first and second areas on the top plate 44 will now be described with reference to FIGS. 5A to 5D. In this immersion exposure apparatus, the liquid LW is easily split at the boundary between the substrate 40 and the top plate 44 since the contact angles of the substrate 40 and the top plate 44 with the immersion liquid differ from each other, and the liquid LW remains on the area having the smaller contact angle more easily.

In particular, remaining of the liquid easily occurs when the substrate 40 is moved over a long distance, for example, 100 mm or more, and the immersion region crosses the substrate 40 and the top plate 44. Furthermore, the upper limit of the moving speed at which remaining of the liquid does not occur very often varies when the liquid LW is moved from the top plate 44 onto the substrate 40 and when the liquid LW is moved from the substrate 40 onto the top plate 44. Since the contact angle of the material forming the surface of the top plate 44 is larger than that of the material applied to the substrate 40, the upper limit of the moving speed at which remaining of the liquid does not occur very often is smaller when the liquid LW is moved from the substrate 40 onto the top plate 44. Even when the moving speed is set such that remaining of the liquid does not occur in each case, remaining of the liquid still easily occurs when the size of the first gap is small.

When the moving speed of the substrate stage is further reduced such that remaining of the liquid does not occur, the throughput is disadvantageously reduced. To solve this, the first area 201 can be partially formed on the top plate 44 adjacent to the substrate 40 as shown in FIG. 5A, and the second area 202 can be formed at the other part on the top plate 44. In this case, the degree to which the liquid remains on the substrate 40 and the second area 202 can be reduced by moving the substrate stage such that an immersion region 500 crosses over the first area 201 from the substrate 40 to the second area 202 of the top plate 44 when the substrate stage is moved for a long distance.

Moreover, as shown in FIG. 5B, the first area 201 can be annular so as to surround the entire circumference (entire outer periphery) of the substrate 40, and the second area 202 can be formed at the other part. When the first area 201 surrounds the entire circumference of the substrate 40, the immersion region 500 can reliably cross the first area 201 from the substrate 40 to the second area 202 of the top plate 44. Thus, the degree to which the liquid remains on the substrate 40 and the second area 202 can be reduced while the moving distance is minimized.

When the first area at least partially surrounds the substrate 40 as shown in FIGS. 5A and 5B, a material whose contact angle with immersion liquid is extremely small can be used for the first area 201. For example, when SiO₂ or SiC having SiO₂ formed on only the surface thereof by heat treatment is used for the first area 201, the contact angle is not changed so much even when the peripheral area of the substrate is irradiated with exposure light. Accordingly, the split immersion liquid can be collected on the first area, and can be drained in a stable manner.

Furthermore, the first area can be formed at a plurality of positions on the top plate 44 as shown in FIG. 5C. The plurality of first areas 201 are arranged, for example, at regular intervals, and the liquid is intentionally made to remain on the first areas. Since the liquid is retained at appropriate intervals, the amount of the extending liquid LW while the substrate stage is moved at high speed over a long distance can be reduced, and at the same time, the degree to which the liquid remains on sites other than the first areas 201 can be reduced. Moreover, since the plurality of first areas 201 are arranged on the top plate 44, the liquid remaining on the second area 202 can be prevented from being moved and splattered from the top plate 44.

Moreover, as shown in FIG. 5D, holes 210 can be formed in the top plate 44, and the first area 201 can be formed at portions adjoining the holes 210 in the top plate 44. Furthermore, measuring members 215 to be irradiated with exposure light can be disposed inside the holes 210. With this structure, the liquid remaining on the measuring members 215 and in the vicinity of the measuring members 215 can be collected on the first areas 201, and can be discharged via the first areas 201. The liquid collected on the first areas can be moved into the corresponding first spaces 203 via openings. Moreover, the liquid moved into the first spaces 203 can be discharged directly from the first spaces 203.

As shown in FIGS. 5A to 5D, the first area 201 is at least partially formed between the substrate 40 and the second area 202 or between the holes 210 and the second area 202 in the immersion exposure apparatus according to this exemplary embodiment. With this structure, the amount of liquid remaining on sites other than the first area 201 is reduced.

The structures shown in FIGS. 5A to 5D can be combined with each other. At least two of the structure shown in FIG. 5A or 5B, that shown in FIG. 5C, and that shown in FIG. 5D can be combined.

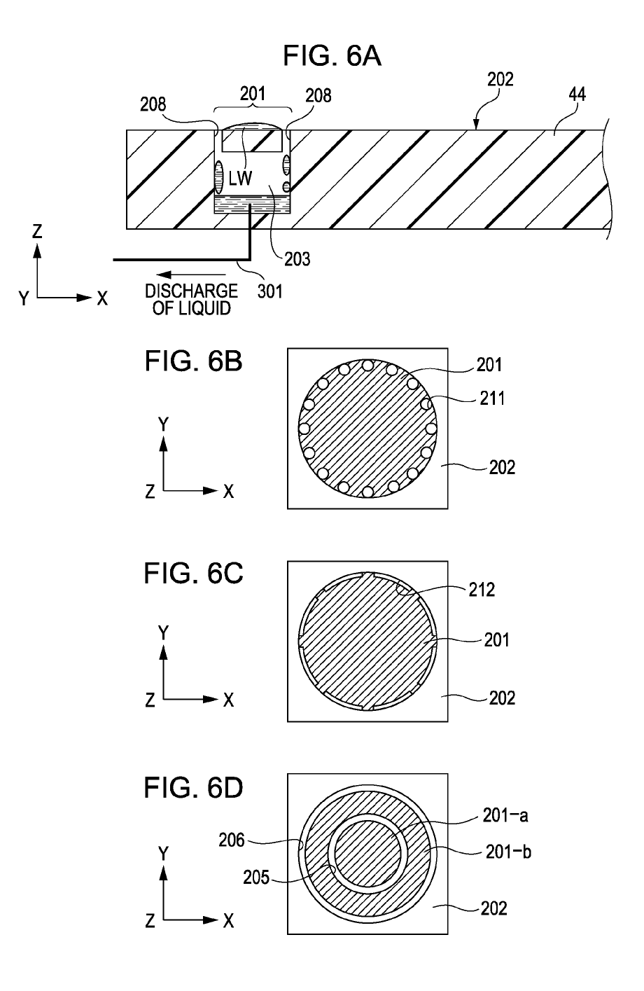

Examples of the openings and the draining mechanism will now be described with reference to FIGS. 6A to 6D.

FIG. 6A is a cross-sectional view illustrating a part in the vicinity of the first space 203 formed in the top plate 44. For example, a plurality of openings 208 are formed inside the first area 201. The liquid brought into contact with the first area 201 is moved into the first space 203 via the openings 208, and discharged from the first space 203. The openings 208 can be pinholes 211 disposed in the vicinity of the boundary between the first area 201 and the second area 202 as shown in FIG. 6B. Moreover, the openings 208 can be slits 212 disposed in the vicinity of the boundary between the first area 201 and the second area 202 as shown in FIG. 6C.

Furthermore, a gap can be formed between the first area 201 and the second area 202 (or each measuring member 215) instead of the pinholes and the slits such that the draining mechanism discharges the liquid via this gap. Although not shown, a groove can be formed at the boundary between the first area 201 and the second area 202, and pinholes and slits can be formed in the groove. Moreover, as shown in FIG. 6D, the first area 201 can be separated into sections 201-a and 201-b, and can have a plurality of gaps (205 and 206) as openings. In this case, the separate first areas (sections 201-a and 201-b) are supported by supporting members (not shown). These supporting members can be composed of different materials. The supporting members can have any structure as long as the liquid can be moved into the first space or the second spaces in the draining mechanism. Although not shown, the supporting members in this structure can include, for example, porous bodies, and can include, for example, openings. Moreover, the supporting members can be, for example, separated into a plurality of sections such that liquid can pass between the sections.

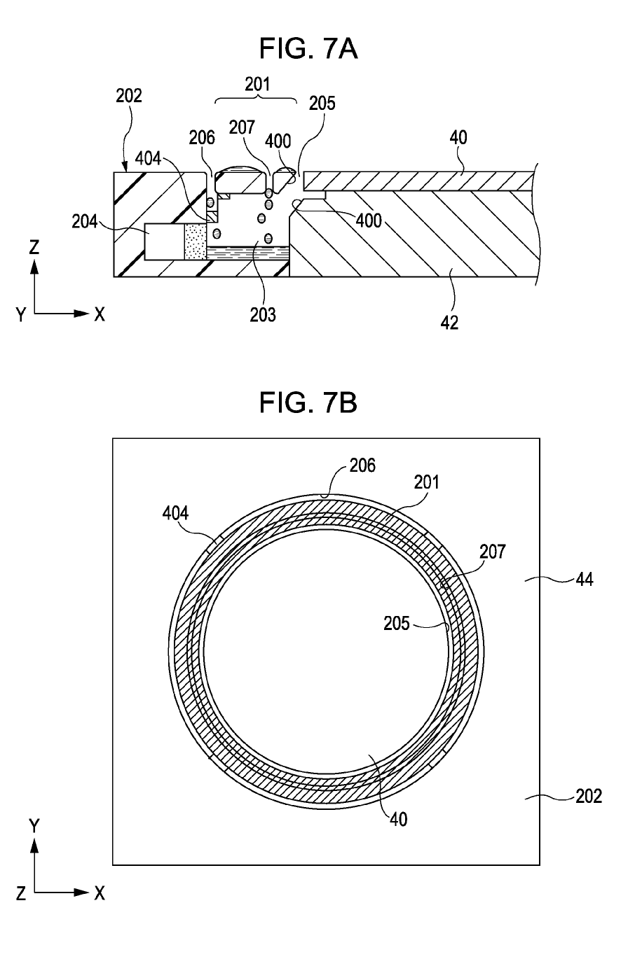

Furthermore, the substrate stage can include a link mechanism that connects a first part including the first area 201 of the top plate 44 and a second part including the second area 202 of the top plate 44. The link mechanism can be, for example, elastic members, such as plate springs 404 shown in FIGS. 7A and 7B, having elasticity in a direction parallel to the first and second areas (surface of the top plate). FIG. 7A is a cross-sectional view of a part in the vicinity of the boundary between the substrate 40 and the top plate 44. FIG. 7B is a top view of the substrate 40 and the top plate 44 viewed in the Z-axis direction.

Unlike the example structure shown in FIGS. 4A and 4B, the part including the first area 201 of the top plate is supported by the plate springs 404 extending from the part including the second area 202 of the top plate in the example structure shown in FIGS. 7A and 7B. The part including the first area 201 of the top plate can be deformed by a reduction in temperature caused by the vaporization of the immersion liquid from the first area 201 composed of a lyophilic material. However, the deformation does not have an effect on the other components such as the part including the second area 202 of the top plate when the part including the first area 201 of the top plate is supported by the plate springs 404. Moreover, the effect of the temperature change in the first area 201 on the other parts of the substrate stage 45 such as the second area 202 can be reduced.

Materials that can be used for the first area 201 and the second area 202 will now be described in detail. The first area 201 can be composed of a lyophilic component or a lyophilic material having a contact angle with liquid of less than 90°. When the liquid is water, for example, the component or the material can include SiO₂, SiC, SiC having SiO₂ formed on only the surface thereof by heat treatment, and highly stable glass ceramic (for example, ZERODUR(R) of Schott make). When the liquid is other than water, materials lyophilic to the liquid, resistant to the liquid, and having a small amount of substance elution can be widely used.

The second area 202 can be composed of a component or a material having a contact angle with the liquid larger than that of the first area 201, resistant to the liquid, and having a small amount of substance elution.

When the liquid is water, for example, the component or the material can include fluorocarbon resin and vapor deposition polymerization resin, which are known as having high water repellency in general. Specifically, polymers including tetrafluoroethylene (TFE) can be widely used as fluorocarbon resin. More specifically, the polymers include polytetrafluoroethylene (PTFE), perfluoroalkyl vinyl ether resin (PFA), and perfluoroethylene-propylene copolymer (FEP). PTFE is a polymer obtained by polymerizing TFE. PFA is a polymer obtained by copolymerizing TFE and perfluoroalkoxyethylene. FEP is a polymer obtained by copolymerizing TFE and hexafluoropropylene.

Moreover, polymers including para-xylylene and those including the derivatives can be widely used as vapor deposition polymerization resin. Specifically, the resin includes Parylene (poly-para-xylylene resin developed by the U.S.'s Union Carbide Chemical and Plastics Co., Inc., (UCC)). More specifically, the resin include Parylene N (trade name of poly-para-xylylene of UCC make), Parylene C (trade name of poly-monochloro-para-xylylene of UCC make), and Parylene D (trade name of poly-dichloro-para-xylylene of UCC make).

The contact angles of these resins with the liquid can be adjusted by changing the degrees of polymerization or the polymerization ratios of the resins or by introducing the functioning groups or the derivatives thereof.

Furthermore, the contact angle of the top plate 44 coated with fluorocarbon resin and the like can be increased by forming uneven or acicular microstructure on the surface of the top plate 44 such that the surface roughness is changed. With this structure, liquid can be efficiently discharged from the top plate 44 via the first area 201. Thus, an exposure apparatus having excellent transfer accuracy, excellent throughput, and long-term stability can be realized.

### Second Exemplary Embodiment

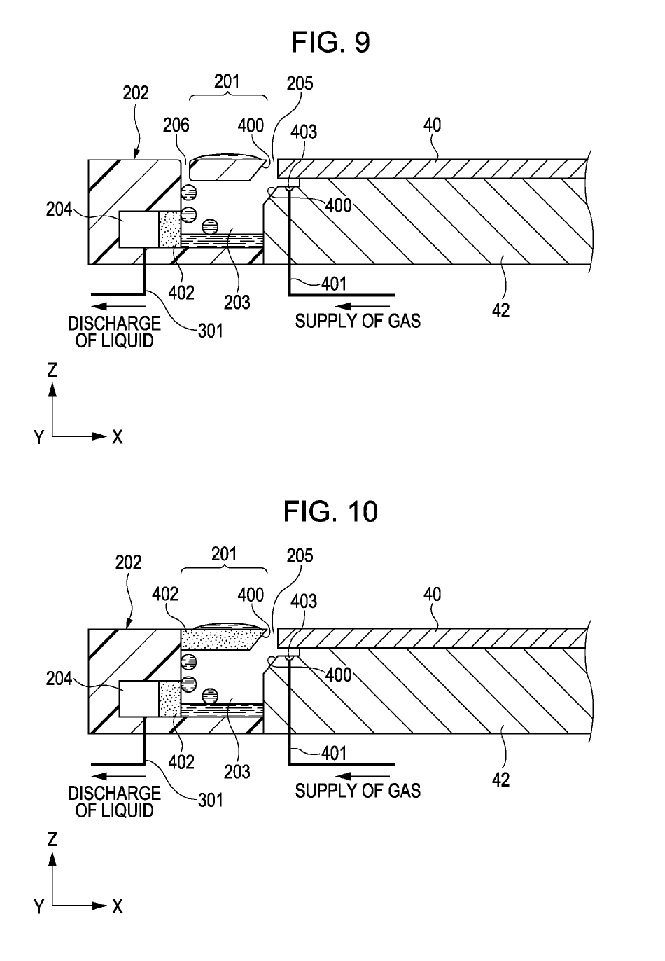

A substrate stage according to another exemplary embodiment of the present invention will now be described with reference to a cross-sectional view shown in FIG. 9. The difference from the substrate stage according to the first exemplary embodiment is that the substrate stage according to this exemplary embodiment has no third gap 207. When the width of the first area 201 is reduced to a few millimeters or less or when the moving speed of the substrate stage 45 is not required to be so high, the third gap 207 can be eliminated.

Moreover, the repellent portions 400 (portions processed so as to be liquid-repellent) at the inclined surfaces of the top plate 44 and the chuck 42 forming the first gap 205 can also be eliminated when the errors in the outer diameter of the substrate are small, when the variations in the first gap 205 can be reduced by using a conveying device with high conveying accuracy, and when the size of the first gap 205 can be sufficiently reduced.

In this exemplary embodiment, the first area 201 is composed of SiC, and the second area 202 is composed of fluorocarbon resin. Furthermore, a surface of the chuck 42 in the vicinity of the gas supply ports 403 formed at positions opposing the back surface of the substrate 40 is processed so as to be liquid-repellent. Moreover, gas is supplied from the gas supply ports 403 in an auxiliary manner such that the liquid collected in the first space 203 is moved into the second spaces 204 connected to the drainage pipes 301. With this structure, the liquid collected on the first area 201 can be efficiently discharged from the top plate 44. Thus, an exposure apparatus having excellent transfer accuracy, excellent throughput, and long-term stability can be realized.

### Third Exemplary Embodiment

A substrate stage according to another exemplary embodiment of the present invention will now be described with reference to a cross-sectional view shown in FIG. 10. The difference from the substrate stages according to the above-described exemplary embodiments is that the first area 201 disposed in the vicinity of the substrate 40 is also composed of the porous body 402. The liquid collected on the first area 201 is moved into the first space 203 via the first gap 205 and the porous body 402, and discharged from the first space 203 via the porous bodies 402 and the second spaces 204. With this structure, the liquid remaining on the top plate 44 can be efficiently discharged. Thus, an exposure apparatus having excellent transfer accuracy and excellent throughput can be realized.

In this exemplary embodiment, the amount of liquid discharged from the first gap 205 is changed since the size of the first gap 205 varies in accordance with the errors in the outer diameter of the substrate and the errors in conveyance of the substrate as described above. Therefore, the repellent portions 400 formed on the inclined surfaces of the porous body 402 and the chuck 42 forming the first gap 205 can stabilize the amount of liquid discharged from the porous body 402 constituting the top plate 44 regardless of the control of the first gap 205. Thus, an exposure apparatus having excellent transfer accuracy, excellent throughput, and long-term stability can be realized.

As in the above-described exemplary embodiments, the repellent portions 400 can be eliminated by using a substrate with fewer errors in the outer diameter thereof and by using a substrate conveying device with high conveying accuracy.

### Fourth Exemplary Embodiment

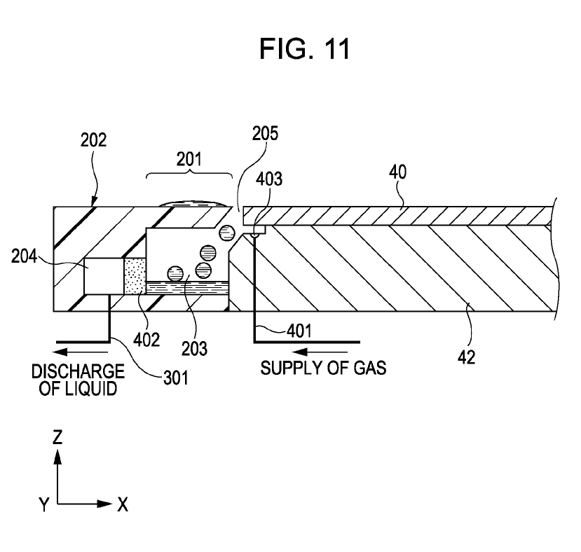

A substrate stage according to another exemplary embodiment of the present invention will now be described with reference to a cross-sectional view shown in FIG. 11. A key feature of this exemplary embodiment is that liquid is discharged from the first area 201 only via the first gap 205 formed in the vicinity of the substrate 40. The size of the first gap 205 can be stabilized at a level suitable for both maintaining and discharging the liquid LW by using a substrate with fewer errors in the outer diameter thereof and by using a substrate conveying device with high conveying accuracy as described above. With this structure, the liquid collected on the first area 201 can be efficiently discharged from the top plate 44 via the first gap 205. Thus, an exposure apparatus having excellent transfer accuracy, excellent throughput, and long-term stability can be realized.

### Fifth Exemplary Embodiment

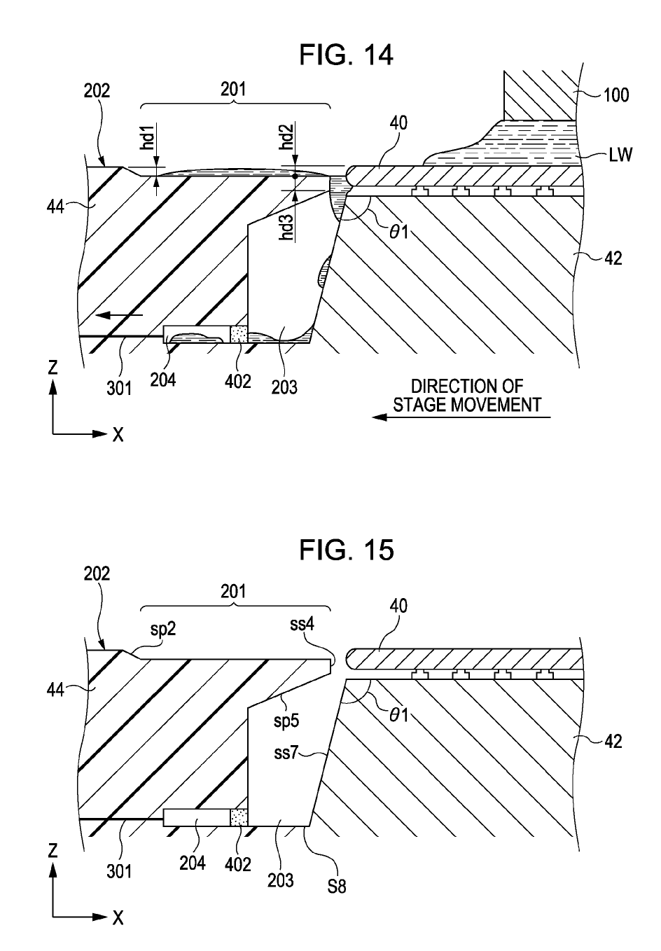

A substrate stage according to another exemplary embodiment of the present invention will now be described with reference to cross-sectional views shown in FIGS. 14 and 15. FIG. 14 illustrates a state where the top plate 44 and the substrate 40 are moved under the nozzle member 100 in the −X direction. FIG. 15, in which reference numbers with reference symbol S are added to surfaces to aid in explanation thereof, illustrates the same state as in FIG. 14.

A feature of this exemplary embodiment is that the height of the top plate 44 is reduced in the vicinity of the substrate 40, that is, the top plate 44 is recessed at a position adjacent to the substrate 40. The first area 201 is formed by reducing the height of the top plate 44 in the vicinity of the substrate 40 by hd2 with respect to the height of the substrate 40, and the second area 202 is formed by increasing the height of the top plate 44 outside the first area 201 by hd1.

Since the first area 201 is lower than the substrate 40 and the second area 202, the liquid can be collected on the first area 201 more easily, and the liquid LW split in accordance with the high-speed movement of the stage can be prevented from being splattered from the first area 201. Moreover, hd1 and hd2 can be set to the thickness of the substrate 40 or less, and more preferably, set to 0.5 mm or less. When hd1 and hd2 are large, air can be taken in at the stepped portion during the high-speed movement of the stage, and bubbles can enter into the liquid LW. This can cause exposure failure.

When the surface forming the first area 201 is inclined toward the substrate 40, the liquid LW collected on the first area 201 can be easily dropped into the first space 203. The liquid collected in the first space 203 can be discharged from the drainage pipes 301 via the porous bodies 402 and the second spaces 204.

When the difference in level between the first area 201 and the second area 202 is large, the liquid can be easily split at the stepped portion, and can remain on the second area 202. Therefore, the first area 201 and the second area 202 can be connected to each other via a slope sp2 as shown in FIG. 15. The contact angle of the slope sp2 with the liquid can be the same as that of the first area 201 or the second area 202, or can be between those of the first area 201 and the second area 202.

When the outer circumferential portion of the substrate 40 passes under the nozzle member 100 while the space between the nozzle member 100 and the substrate 40 is filled with the liquid LW, the liquid LW can be partially retained at a gap formed between the side surface of the substrate 40 and a side surface ss4 of the top plate 44, and can reach the back surface of the substrate 40. To avoid this, the thickness hd3 of the top plate 44 at the side surface ss4 is set to half or less the thickness of the substrate 40 so that the liquid LW is not easily retained at the gap formed between the side surface of the substrate 40 and the side surface ss4 of the top plate 44.

Furthermore, when a slope sp5 forming a part of the first space 203 is processed so as to be liquid-repellent and the contact angle of the slope sp5 with the liquid LW is increased as compared with that of a side surface ss7 of the chuck 42, the liquid LW can be easily dropped along the side surface ss7 of the chuck 42. As a result, the liquid LW can be prevented from remaining at the gap formed between the side surface of the substrate 40 and the side surface ss4 of the top plate 44.

Furthermore, when the contact angle of a surface S8 forming the first space 203 with the liquid LW is reduced as compared with that of the side surface ss7 of the chuck with the liquid LW, the liquid collected in the first space can be efficiently recovered from the porous bodies 402.

When the amount of liquid dropped from the gap formed between the side surface of the substrate 40 and the side surface ss4 of the top plate 44 into the first space 203 is too large, an angle θ1 of the chuck 42 can be set to 90° or more, or more preferably, 120° or more so that the amount of the liquid dropped from the gap is reduced.

When the angle θ1 is increased, the size of the gap formed between the slope sp5 of the top plate 44 and the side surface ss7 of the chuck 42 can be reduced. With this, the liquid collected in the first space 203 is prevented from being agitated in accordance with the movement of the substrate stage 45 and splattered from the gap formed between the inclined surfaces of the top plate 44 and the chuck 42 onto the surface of the substrate 40 and the like.

In the above-described exemplary embodiments, the contact angle of the first area 201 with the liquid LW is smaller than that of the second area 202. In this exemplary embodiment, the split liquid can be collected on the first area 201 by reducing the height of the first area 201 as compared with those of the substrate 40 and the second area 202. Therefore, the contact angle of the first area with the liquid LW can be the same as that of the second area. Moreover, when the contact angle of the first area with the liquid LW is reduced as compared with that of the second area as in the above-described exemplary embodiments, the split liquid can be collected on the first area 201 more efficiently.

### Sixth Exemplary Embodiment

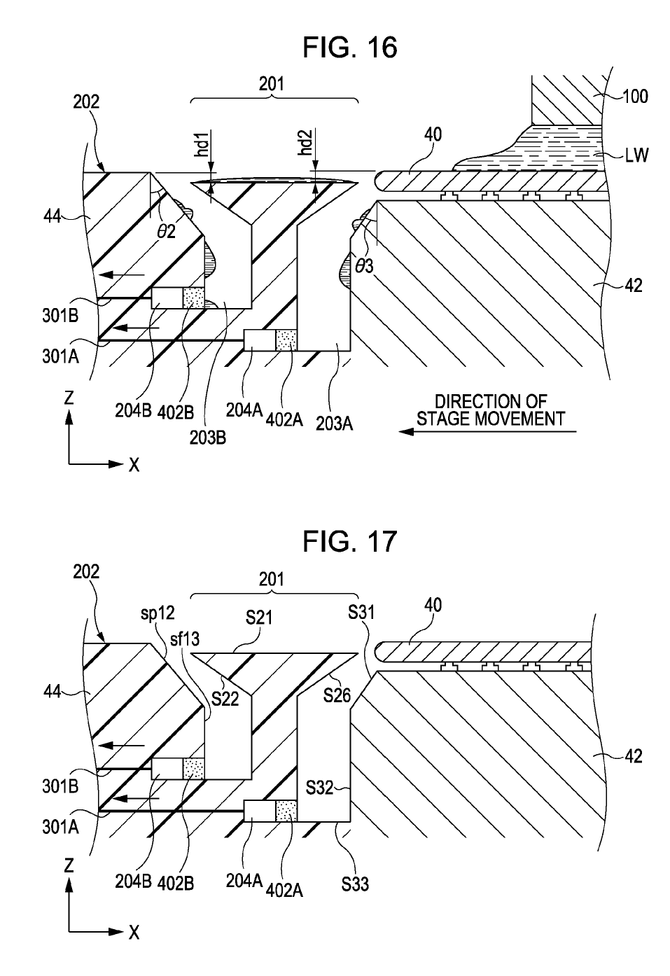

A substrate stage according to another exemplary embodiment of the present invention will now be described with reference to cross-sectional views shown in FIGS. 16 and 17. FIG. 16 illustrates a state where the top plate 44 and the substrate 40 are moved under the nozzle member 100 in the −X direction. FIG. 17, in which reference numbers with reference symbol S are added to surfaces to aid in explanation thereof, illustrates the same state as in FIG. 16.

A feature of this exemplary embodiment is that a flow channel for drainage is formed between the first area 201 and the second area 202 in addition to that described in the above-described exemplary embodiments.

The liquid can be collected on the first area 201 more easily by reducing the height of the first area 201 as compared with those of the substrate 40 and the second area 202. With this, the liquid LW split in accordance with the high-speed movement of the stage can be prevented from being splattered from the first area 201.

In this exemplary embodiment, the liquid can be discharged from both sides of the first area since the flow channel for drainage is formed between the first area 201 and the second area 202. Therefore, the split liquid LW can be prevented from being splattered from the first area 201 onto the substrate 40 and the second area even when the width of the first area is a few tens of millimeters.

The liquid collected in a first space 203A can be discharged from drainage pipes 301A via porous bodies 402A and second spaces 204A.

Moreover, the liquid collected in a first space 203B can be discharged from drainage pipes 301B via porous bodies 402B and second spaces 204B.

Furthermore, when a slope S26 forming a part of the first space 203A and a slope S22 forming a part of the first space 203B are processed so as to be liquid-repellent, the liquid LW can be easily dropped along a surface S31 of the chuck 42 and a slope sp12 of the second area 202. As a result, the liquid LW can be prevented from remaining on a surface S21 of the first area 201, and the split liquid LW can be prevented from being splattered onto the substrate 40 and the second area.

Furthermore, when the contact angle of a surface sf13 forming the first space 203B with the liquid LW is reduced as compared with that of the slope sp12 of the second area with the liquid LW, the liquid can be moved from the slope sp12 to the surface sf13 more easily. With this structure, the liquid collected in the first space 203B can be efficiently recovered from the porous bodies 402B.

Moreover, when the contact angles of surfaces S32 and S33 with the liquid LW are reduced as compared with the contact angle of the surface S31 with the liquid LW, the liquid can be moved from the surface S31 to the surface S32 more easily. With this structure, the liquid collected in the first space 203A can be efficiently recovered from the porous bodies 402A.

When the amount of liquid dropped from the gap formed between the slope S26 and the surface S31 into the first space 203A is too large, an angle 03 of the chuck 42 can be set to 0° or more, or more preferably, 30° or more so that the amount of the liquid dropped from the gap is reduced. Moreover, when the amount of liquid dropped from the gap formed between the slope sp12 and the slope S22 into the first space 203B is too large, an angle θ2 of the chuck 42 can be set to 0° or more, or more preferably, 30° or more so that the amount of the liquid dropped from the gap is reduced.

### Seventh Exemplary Embodiment

### [Method for Manufacturing Device]

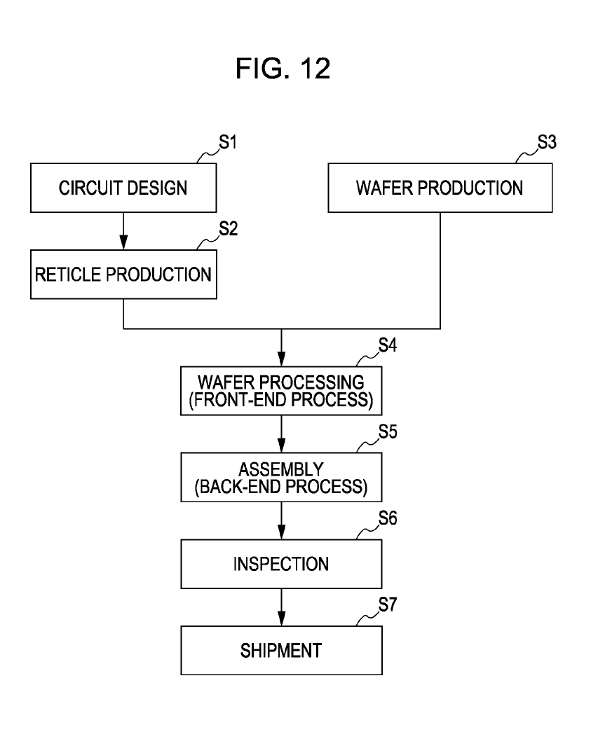

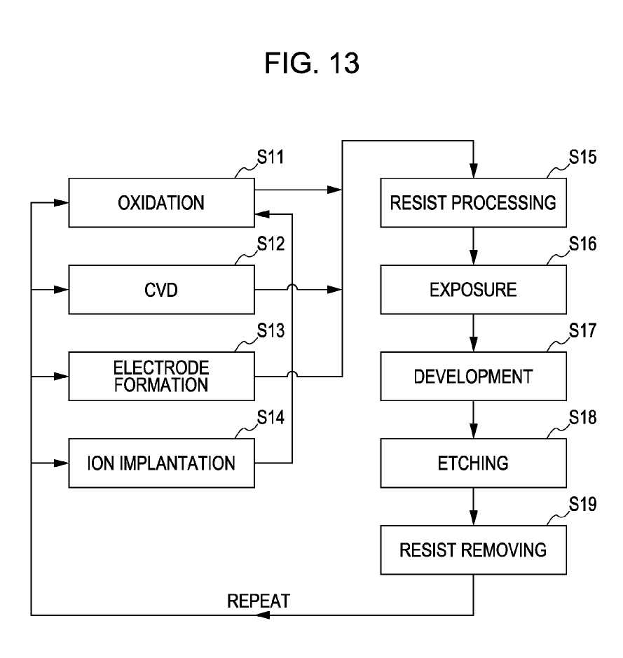

Next, a method for manufacturing devices using the above-described exposure apparatus 1 will be described with reference to FIGS. 12 and 13. FIG. 12 is a flow chart of manufacturing devices, for example, semiconductor chips such as ICs and LSI circuits, LCDs, or CCD sensors. Herein, a method for manufacturing semiconductor devices will be described as an example.

In Step S1 (circuit design), circuits of semiconductor devices are designed. In Step S2 (reticle production), reticles (also referred to as originals or masks) having the designed circuit patterns formed thereon are produced. In Step S3 (wafer production), wafers (also referred to as substrates) are produced using materials such as silicon. Step S4 (wafer processing) is referred to as a front-end process in which real circuits are formed on the wafers with lithography technology using the reticles and the wafers. Step S5 (assembly) is referred to as a back-end process in which semiconductor devices are produced using the wafers processed in Step S4. Step S5 includes an assembly process (dicing and bonding), a packaging process (molding), and the like. In Step S6 (inspection), operations, durability, and the like of the semiconductor devices produced in Step S5 are checked. The semiconductor devices produced through these steps are then shipped (Step S7).

FIG. 13 is a flow chart illustrating the wafer processing in Step S4 in detail. In Step S11 (oxidation), the surfaces of the wafers are oxidized. In Step S12 (chemical vapor deposition; CVD), insulating films are deposited on the surfaces of the wafers. In Step S13 (electrode formation), electrodes are formed on the wafers by, for example, vapor deposition. In Step S14 (ion implantation), ions are implanted in the wafers. In Step S15 (resist processing), photosensitizer (also referred to as resist) is applied to the wafers. In Step S16 (exposure), the wafers are exposed to light via the circuit patterns of the reticles using the above-described exposure apparatus 1. In Step S17 (development), the exposed wafers are developed. In Step S18 (etching), the wafers are etched using the resist patterns, obtained by the development, as masks. In Step S19 (resist removing), the resist that is no longer required after etching is removed. Repetition of these steps can form multiplex circuit patterns on the wafers. In the method for manufacturing devices according to the exemplary embodiment, high-quality devices as compared with those according to known technologies can be manufactured.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-036600 filed Feb. 16, 2007 and Japanese Application No. 2007-295594 filed Nov. 14, 2007, which are hereby incorporated by reference herein in their entirety.

What is claimed is:

1. An exposure apparatus for exposing a substrate via liquid, comprising:
a projection optical system configured to project a pattern of an original onto the substrate; and
a substrate stage configured to hold and move the substrate; the substrate stage including,
a chuck configured to hold the substrate;
a top plate surrounding the substrate held by the chuck; and
a draining mechanism configured to drain liquid on the top plate;
wherein the top plate has a first area and a second area on the surface of the top plate,
wherein at least part of the first area is formed between the substrate held by the chuck and the second area,
wherein the contact angle of the first area with the liquid is smaller than the contact angle of the second area with the liquid, and
wherein the draining mechanism drains liquid on the first area.

2. An exposure apparatus for exposing a substrate via liquid, comprising:
a projection optical system configured to project a pattern of an original onto the substrate; and
a substrate stage configured to hold and move the substrate; the substrate stage including,
a chuck configured to hold the substrate;
a top plate surrounding the substrate held by the chuck; and
a draining mechanism configured to drain liquid on the top plate;
wherein the top plate has a first area and a second area on the surface of the top plate,
wherein at least part of the first area is formed between the substrate held by the chuck and the second area,
wherein the draining mechanism drains liquid on the first area, and
wherein the distance from a surface of a lens, the surface being brought into contact with the liquid, in the projection optical system to the first area is larger than the distance from the surface of the lens to the surface of the substrate held by the chuck and the distance from the surface of the lens to the second area.

3. An exposure apparatus for exposing a substrate via liquid, comprising:
a projection optical system configured to project a pattern of an original onto the substrate; and
a substrate stage configured to hold and move the substrate; the substrate stage including,
a chuck configured to hold the substrate;
a top plate surrounding the substrate held by the chuck; and
a draining mechanism configured to discharge liquid disposed on the top plate,
wherein the top plate has a first area and a second area on the surface of the top plate,
wherein the contact angle of the first area with the liquid is smaller than the contact angle of the second area with the liquid, and
wherein the draining mechanism drains the liquid via an opening formed in the first area.

4. An exposure apparatus for exposing a substrate via liquid, comprising:
a projection optical system configured to project a pattern of an original onto the substrate; and
a substrate stage configured to hold and move the substrate; the substrate stage including,
a chuck configured to hold the substrate;
a top plate surrounding the substrate held by the chuck;
a draining mechanism configured to drain liquid on the top plate; and a measuring member disposed inside a hole formed in the top plate;
wherein the top plate has a first area and a second area on the surface of the top plate,
wherein at least part of the first area is formed between the hole and the second area,
wherein the contact angle of the first area with the liquid is smaller than the contact angle of the second area with the liquid, and
wherein the draining mechanism drains liquid on the first area.

5. The exposure apparatus according to claim 1,
wherein the substrate held by the chuck and the first area are adjacent to each other with a gap therebetween, and
wherein the draining mechanism drains the liquid via the gap formed between the substrate held by the chuck and the first area.

6. The exposure apparatus according to claim 1,
wherein the first area and the second area are adjacent to each other with a gap therebetween, and
wherein the draining mechanism drains the liquid via the gap formed between the first area and the second area.

7. The exposure apparatus according to claim 2,
wherein the contact angle of the first area with the liquid is smaller than the contact angle of the second area with the liquid.

8. The exposure apparatus according to claim 4,
wherein the measuring member and the first area are adjacent to each other with a gap therebetween, and
wherein the draining mechanism drains the liquid via the gap formed between the measuring member and the first area.

9. The exposure apparatus according to claim 1,
wherein a part including the first area of the top plate is composed of a porous material, and
wherein the draining mechanism drains the liquid via the porous material.

10. The exposure apparatus according to claim 1,
wherein the first area and the second area are adjacent to each other with a gap therebetween, and
wherein the top plate is separated into a first part including the first area and a second part including the second area.

11. The exposure apparatus according to claim 10,
wherein the substrate stage includes a link mechanism that connects the first part and the second part, and
wherein the link mechanism includes an elastic member having elasticity in a direction parallel to the surface of the top plate.

12. The exposure apparatus according to claim 1,
wherein the distance from a surface of a lens, the surface being brought into contact with the liquid, in the projection optical system to the first area is larger than the distance from the surface of the lens to the surface of the substrate held by the chuck and the distance from the surface of the lens to the second area.

13. The exposure apparatus according to claim 12,
wherein the difference between the distance from the surface of the lens to the surface of the substrate held by the chuck and the distance from the surface of the lens to the first area and the difference between the distance from the surface of the lens to the first area and the distance from the surface of the lens to the second area are smaller than or equal to the thickness of the substrate.

14. The exposure apparatus according to claim 1,
wherein the contact angle of the first area with the liquid is less than 90°.

15. A method for manufacturing a device using an exposure apparatus for exposing a substrate via liquid, the apparatus including,
a projection optical system configured to project a pattern of an original onto the substrate; and
a substrate stage configured to hold and move the substrate; the substrate stage including,
a chuck configured to hold the substrate;
a top plate surrounding the substrate held by the chuck; and
a draining mechanism configured to drain liquid on the top plate;
wherein the top plate has a first area and a second area on the surface of the top plate,
wherein at least part of the first area is formed between the substrate held by the chuck and the second area,
wherein the contact angle of the first area with the liquid is smaller than the contact angle of the second area with the liquid, and
wherein the draining mechanism drains liquid on the first area; the method comprising:
exposing a substrate using the exposure apparatus; and
developing the exposed substrate.
